(19) United States
(12) Patent Application Publication
(10) Pub. No.: US 2025/0259800 A1
(43) Pub. Date: Aug. 14, 2025

(54) Polymer Capacitors with Improved Reliability

(71) Applicant: KEMET Electronics Corporation, Fort Lauderdale, FL (US)

(72) Inventors: Antony Chacko, Simpsonville, SC (US); John Ols, Simpsonville, SC (US); Subarna Banerjee, Simpsonville, SC (US)

(21) Appl. No.: 18/441,695

(22) Filed: Feb. 14, 2024

(51) Int. Cl. H01G 9/028; C08G 65/00; C08L 25/18; H01G 9/00; H01G 9/15

(52) U.S. Cl. CPC H01G 9/028; C08G 65/00; C08L 25/18; H01G 9/0036; H01G 9/15

(57) ABSTRACT

Provided is a solid electrolytic capacitor with an improve capacitance stability. The capacitor comprises an anode with a dielectric on the anode. A cathode is on the dielectric wherein the cathode comprises a first solid electrolyte layer wherein the first solid electrolyte layer preferably comprises a first polymer and has a first glass transition temperature. A second solid electrolyte layer is on the first solid electrolyte layer wherein the second solid electrolyte layer preferably comprises a second polymer and has a second glass transition temperature which is higher than the first glass transition temperature.

### FIELD OF THE INVENTION

This present invention is related to solid electrolyte capacitors with improved reliability. More specifically, the present invention is related to solid electrolytic capacitors comprising a first solid electrolyte closest to the dielectric, wherein the first solid electrolyte has a low T_{g} (glass transition temperature) more preferably comprises a first polymer with a high T_{g}, and a second solid electrolyte, on the first solid electrolyte, wherein the second solid electrolyte has a high T_{g} and more preferably comprises a second polymer with a high T_{g}.

### BACKGROUND

Capacitors comprising a tantalum anode and a cathode comprising a solid electrolyte formed from conductive polymer cathodes are increasingly being used for applications demanding high reliability. These capacitors are particularly important in automotive, medical, military and space systems. Due to the higher performance, and superior quality, achieved in recent history polymer capacitors are the preferred components for many applications.

The application of an intrinsically conducting polymer material as the cathode for tantalum capacitors results in significantly lower equivalent series resistance (ESR) when compared to MnO₂ cathode systems. Though there are several intrinsic conducting polymer based solid electrolytes, solid electrolytic capacitors comprising polythiophene based conductive polymers have proven to be the most desirable. Solid conductive polymer capacitors use a conductive polymer material based on poly-(3,4-ethylenedioxythiophene) (PEDOT) as the solid electrolyte is the most promising conducting polymer due to its high conductivity, high thermal stability, and commercial availability. Several commercial applications in electrical and optical devices have been developed utilizing the conducting properties of the in-situ polymerized layers of the 3,4-ethylenedioxythiophene monomer doped with p-toluene sulfonate (TOS) molecules and PEDOT complex with an acid such as polystyrene sulfonic acid (PSSA) wherein the ratio of conductive polymer and polystyrene sulfonic acid is a design choice the optimization of which is well known to those of skill in the art.

In recent years there has been significant increase of electronics content and passive components in automotive systems due to real time sensing and automation. Some of these automotive applications require polymer capacitors with higher capacitance and higher capacitance stability. As demands continued to increase, those of skill in the art have continued to refine the art of valve metal capacitor manufacturing resulting in powders with higher charge density which now exceed 50,000 CV/g. As the charge density of the powder increases the internal surface area of the anode formed from the powder increases and the pore size of the pressed powder decreases. The smaller pore size, in particular, complicates the use of conductive polymer cathodes since it is difficult to deposit conductive polymer on the interstitial surfaces of the anode to the degree necessary to sufficiently cover the surface of the dielectric.

The problem of poor interstitial surface area coverage has been significantly mitigated by the application of multiple layers of conductive polymer wherein the internal layers and external layers are different formulations. One approach, which has enjoyed much success, is the formation of a primary conductive polymer layer, the one directly on the dielectric, by in-situ polymerization wherein monomers of the polymer are polymerized in-situ. Though this is beneficial for the formation of the initial layer the outer layers of conductive polymer are preferably formed from slurries of pre-formed conductive polymer. The conductive polymer slurries are prepared from a dispersion of PEDOT: Polyanion particles and other additives in water. The polyanion can be polystyrene sulphonic acid (PSSA) or their copolymers. Such polyanion copolymers are described in U.S. Pat. No. 10,340,091. Forming a conductive polymer coating, from a preformed polymer, on an in-situ formed polymer, has proven difficult and is believed to be a primary factor in mitigating the ability to achieve the expected advantages provided by the conductive polymer based cathode.

An alternative method is the formation of the primary conductive polymer layer from a slurry of preformed conductive polymer wherein the slurry has very small particles of conductive polymer, including below detectable limits, wherein the conductive polymer is referred to herein as being soluble. The in-situ method and the use of very small particles are advantageous for coating the interstitial areas of a porous anode to form a coating on the dielectric thereon. Secondary conductive layers are then preferably formed on the primary conductive polymer layer by the deposition of slurries comprising preformed conductive polymer.

The use of different formulations or techniques for depositing the conductive polymer has led to a reduction in the capacitance stability of the capacitor, particularly, during power cycling. While not limited to theory it is hypothesized that either the polymer layers are incompatible or insufficiently fill the pores or electronic energy level mismatch with the layer adjacent to the dielectric. Incompatibility of adjacent layers could lead to poor adhesion, or delamination, upon power cycling within the polymer layers themselves or at the dielectric.

Provided herein is an improved solid electrolyte material composition and capacitor comprising making a capacitor comprising the solid electrolyte wherein the deficiencies of the existing art are significantly mitigated.

### SUMMARY OF THE INVENTION

The present invention is related to an improved solid electrolytic capacitor, particularly, with improved reliability.

A particular feature of the invention is improved stability after power cycling.

An advantage of the invention is the ability to form the capacitor using conventional manufacturing equipment and processes.

These and other advantages, as will be realized, are provided in a solid electrolytic capacitor with an improve capacitance stability. The capacitor comprises an anode with a dielectric on the anode. A cathode is on the dielectric wherein the cathode comprises a first solid electrolyte layer wherein the first solid electrolyte layer comprises a first polymer with a glass transition temperature below 0° C. A second solid electrolyte layer is on the first solid electrolyte layer wherein the second solid electrolyte layer comprises a second polymer with a glass transition temperature of at least 50° C.

Yet another embodiment is provided in a solid electrolytic capacitor with an improved capacitance stability. The capacitor comprises an anode with a dielectric on the anode. A cathode is on the dielectric wherein the cathode comprises a first solid electrolyte layer wherein the first solid electrolyte layer comprises a first polymer with a first glass transition temperature and a second solid electrolyte layer wherein the second solid electrolyte layer comprises a second polymer with a second glass transition temperature which is higher than the first glass transition temperature.

Yet another embodiment is provided in a solid electrolytic capacitor with an improved capacitance stability. The capacitor comprises an anode with a dielectric on the anode and a cathode on the dielectric. The cathode comprises a first solid electrolyte layer with a first ionic conductivity and a second solid electrolyte layer with a second ionic conductivity wherein the first ionic conductivity is higher than the second ionic conductivity.

Yet another embodiment is provided in a solid electrolytic capacitor with an improved capacitance stability. The capacitor comprises an anode with a dielectric on the anode and a cathode on the dielectric. The cathode comprises a first solid electrolyte layer with a glass transition temperature below 0° C.; and a second solid electrolyte layer with a glass transition temperature of at least 50° C. After at least 50,000 surge cycles the solid electrolytic capacitor exhibits a capacitance loss of less than 15%.

Yet another embodiment is provided in a method for forming a solid electrolytic capacitor comprising:

forming a dielectric on an anode; and
forming a cathode on the dielectric wherein the cathode comprises:
forming a first solid electrolyte layer wherein the first solid electrolyte layer comprises a first polymer with a glass transition temperature below 0° C.; and
forming a second solid electrolyte layer on the first solid electrolyte layer wherein the second solid electrolyte layer comprises a second polymer with a glass transition temperature of at least 50° C.

Yet another embodiment is provided in a method for forming a solid electrolytic capacitor comprising:

forming a dielectric on an anode; and
forming a cathode on the dielectric wherein the cathode comprises:
forming a first solid electrolyte layer wherein the first solid electrolyte layer has an ionic conductivity
forming a second solid electrolyte layer on the first solid electrolyte layer wherein the second solid electrolyte layer has an ionic conductivity lower than the first solid electrolyte ionic conductivity.

### BRIEF DESCRIPTION OF DRAWINGS

FIG. 1 is a cross-sectional schematic view of an embodiment of the invention.

FIG. 2 is a flow chart representation of an embodiment of the invention.

FIG. 3 is a graphical representation of the present invention.

### DESCRIPTION

The present invention is related to an improved solid electrolyte capacitor which exhibits significantly improved stability over many cycles of power cycle testing. More specifically, the present invention is related to an electrolytic capacitor comprising a first solid electrolyte layer, closest to the dielectric, comprising a first polymer, wherein the first solid electrolyte layer has a first glass transition temperature (T_{g}) which is preferably below 0° C. to no less than −80° C. and having a first ionic conductivity and a second solid electrolyte layer, on the first solid electrolyte layer, comprising a second polymer, wherein the second electrolyte layer has a second glass transition temperature which is higher than the Tg of the first solid electrolyte layer, and preferably at least 50° C. to no more than 200° C. wherein the second electrolyte layer also has a second ionic conductivity which is lower than the first ionic conductivity.

Physical and chemical properties of the polymers in the solid electrolyte layers are dramatically affected by the cooperative segmental motion of the polymer chains. The best indicator of the segmental motion and the molecular mobility is the glass transition temperature (Tg). Some solid electrolytes exhibit both electronic conductivity and ionic conductivity. Electronic conductivity in semiconductors, such as conducting polymers, is due to the movement of electrons or holes in response to an electric field. Ionic conductivity is conductivity due to the motion of ionic charge. Ionic conductivity can be determined from Nyquist plots using an electrochemical impedance (EIS) analyzer. Nyquist plot is derived by plotting the imaginary impedance vs real impedance.

It is hypothesized that by controlling the glass transition temperature of the layers and, the charge mobility at the layer interface and the bulk are improved. This reflects in an enhanced ionic conductance values. This mitigates the resistance across the layer interface. Provided herein is a solid electrolyte material composition which facilitates the charge mobility at the polymer-dielectric interface.

The invention will be described with reference to the figures which are an integral, but non-limiting, part of the specification provided for clarity of the invention.

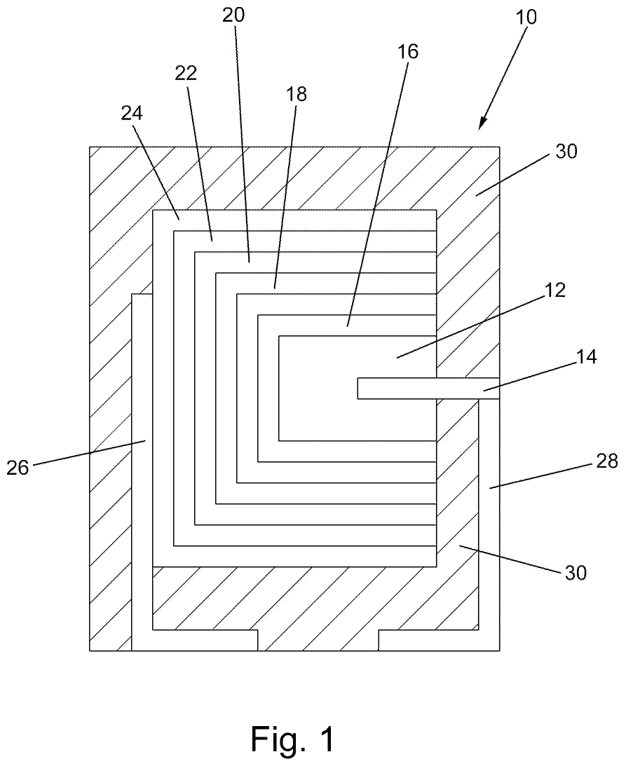

An embodiment of the invention will be described with reference to FIG. 1. In FIG. 1, an inventive capacitor, 10, is illustrated schematically in cross-sectional view. The capacitor comprises an anode, 12, which is preferable a porous monolith formed by pressing a powder. An anode wire, 14, extends from the anode. The anode wire can be embedded in the powder prior to pressing, which is preferred, or the anode wire can be attached to the surface of the anode after pressing such as by welding. A dielectric, 16, is formed on the surface of the anode. While illustrated as a layer of consistent thickness the actual dielectric layer is on the interstitial surfaces of the porous monolith. An optional, but preferred internal layer, 17, is on the dielectric wherein the internal layer is preferably an in-situ formed layer. A first solid electrolyte layer, 18, is on the internal layer, or dielectric, and preferably extends into the interstitial surfaces of the monolith to increase the surface area of conductive polymer coating. The first solid electrolyte layer preferably comprises a first polymer with a first glass transition temperature which is preferably below 0° C. A low glass transition temperature increases the ionic conductivity in the layer. A second solid electrolyte layer, 20, is formed on the first solid electrolyte layer wherein the second solid electrolyte layer preferably comprises a second polymer with a glass transition temperature which is higher than the glass transition temperature of the first polymer and preferably above 50° C. The higher glass transition temperature decreases the ionic conductivity of the layer and therefore the ionic conductivity of the second solid electrolyte layer is lower than the ionic conductivity of the first solid electrolyte layer. A first adhesion layer, 22, preferably comprising carbon, is optionally but preferably formed on the second solid electrolyte layer. A second adhesion layer, 24, preferably comprising a solderable metal, is optionally but preferably formed on the first adhesion layer. The adhesion layers allow electrical attachment of a cathode lead, 26, to the solid electrolyte layers such as by soldering or by a conductive adhesive as known in the art. It is known in the art that attachment of a lead to a conductive polymer layer is difficult and an adhesion layer is typically used to allow good physical and electrical contact between the secondary conductive polymer layer and cathode lead. An anode lead, 28, is in electrical contact with the anode wire. An optional but preferred electrically insulating resin, 30, encases all but the bottom portion of the cathode lead and anode lead.

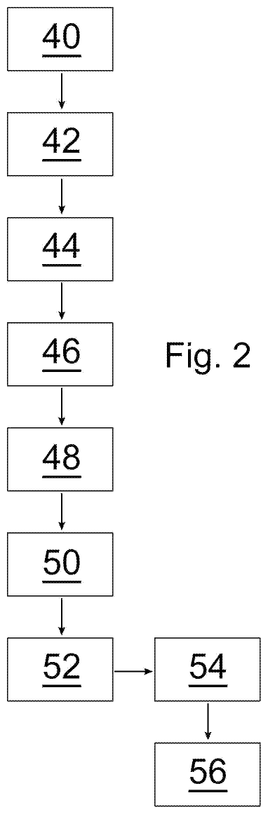

The process for forming the electrolytic capacitor will be described with reference to FIG. 2. In FIG. 2 the process for forming an electrolytic capacitor is represented in a flow chart. An anode is prepared at 40. The anode can be a foil or the anode can be prepared by pressing a powder. A pressed powder anode preferably comprises an anode wire extending therefrom. The anode is preferably sintered, particularly if a powder of niobium or tantalum is used as the anode powder. A dielectric is formed on the anode at 42. The method of forming the dielectric is not limiting with typical methods known to those of skill in the art suitable for demonstration of the invention. An optional, but preferred internal layer is formed at 44 and preferably by in-situ polymerization. A first solid electrolyte layer is formed on the dielectric at 46. The first solid electrolyte layer is preferably applied as a slurry comprising a pre-formed conductive first polymer preferably with an average particle size of less than 20 nm and preferably below 1 nm. Below about 1 nm the particles are generally considered non-detectable at which point the pre-formed conductive polymer is referred to as a soluble polymer.

The solid electrolyte comprises a conductive polymer, a polyanion, a film forming polymer, and additives such as adhesion promoters, crosslinkers, dopants, surfactants etc. The concentration of the conducting polymer can be varied from 20% to 95%. The composition of the film forming polymer can be varied from 5% to 80%. Additive concentrations vary from 10% to 50%.

The first solid electrolyte layer is typically formed on the dielectric or internal layer by multiple applications of slurry with each layer comprising a first film forming polymer as described elsewhere herein. A second solid electrolyte layer is preferably applied to the first solid electrolyte layer at 48. The second solid electrolyte layer is preferably formed by applying a slurry comprising a conductive polymer, which can be the same as the first conductive polymer wherein the second conductive polymer has an preferable average particle size of at least 50 nm to no more than 200 nm and more preferably no more than 150 nm even more preferably no more than 100 nm. The second conductive polymer can also have a bimodal particle size distribution. Such properties of conducting polymer are described in U.S. Pat. No. 10,650,980 and U.S. Pat. No. 10,658,121. The second solid electrolyte layer is preferable formed from multiple applications of slurry wherein each application comprises a second polymer as described elsewhere herein. A first adhesion layer is preferably applied to the second solid electrolyte layer at 50. A second adhesion layer is preferably formed on the first adhesion layer at 52. The cathode lead is attached to the second adhesion layer at 54 and the capacitor is finished at 56 by attaching the anode lead to the anode wire, optional resin encapsulation, optional testing and any optional electrical or physical treatment.

Particularly preferred first polymers having a low T_{g}, preferably below 0° C. and preferably selected from the group consisting of: poly(triethyleneglycol methyl vinyl ether); poly[2-(2-ethoxy)ethoxyethyl vinyl ether]; poly(2-ethoxyethyl vinyl ether); poly(ethyl vinyl ether); poly(iso-propyl vinyl ether); poly(n-propyl vinyl ether); poly(n-butyl vinyl ether); poly(iso-butyl vinyl ether); poly(2-ethylhexyl vinyl ether); poly(trimethylene carbonate-co-ε-caprolactone); polytrimethylene oxide; poly(ethylene) oxide; poly(propylene oxide); poly(ethylene oxide)-co-poly(propylene oxide) copolymers; polyvinylidene fluoride; poly(vinylidene fluoride-hexafluoropropylene); poly(ethylene imine); poly(3-hydroxypropyl ethyleneimine); poly[bis((methoxyethoxy)ethoxy)phosphazene]; poly[bis{poly(ethylene glycol) methylether}phosphazene]; poly[bis{poly(oxyethylene(4)) laurylether}phosphazene] and oly[bis-((methoxyethoxy)ethoxy)phosphazene].

Particularly preferred second polymers having a high T_{g}, preferably of at least 50° C. and are preferably selected from the group consisting of: polyester, polyurethane, polyamide, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins or reactive polyamides.

The solid electrolyte comprises a conductive polymer, a polyanion, a film forming polymer, and additives such as adhesion promoters, crosslinkers, dopants, surfactants etc. The concentration of the conducting polymer can be varied from 20% to 95%. The composition of the film forming polymer can be varied from 5% to 80%. Additive concentrations varies from 10% to 50%.

A particularly preferred anode material is a metal and a particularly preferred metal is a valve metal or a conductive oxide of a valve metal. Particularly preferred anodes comprise a material selected from the group consisting of niobium, aluminum, tantalum and NbO. Tantalum is the most preferred anode material. While not limited thereto, the advantages of the invention are most easily appreciated with high charge density powders such as above 50,000 CV/g. Below about 50,000 CV/g the issues related to power cycling are not as prevalent and therefore the advantages offered by the invention are not as readily realized. As the powder charge density increases the advantages of the invention are more readily apparent. Particularly preferred powders have a charge density above 100,000 CV/g, preferably above 200,000 CV/g and even more preferably above about 250,000 CV/g up to about 350,000 CV/g.

The anode wire is either embedded in or attached to the anode with a preference for an embedded anode wire. The material of construction for the anode wire is not particularly limited, however, it is preferable that the anode wire be the same material as the anode for manufacturing conveniences.

The dielectric, and method of forming the dielectric, is not particularly limited herein. A particularly preferred dielectric is an oxide of the anode due to manufacturing considerations.

The solvent for the slurry comprising the conductive polymer and additional polymer can be water, organic solvents, or mixtures of water with miscible solvents such as alcohol and non-hydroxy polar solvents such as dimethyl sulfoxide (DMSO), dimethylformamide (DMF), dimethylacetamide (DMAc), etc. It is preferable that the slurry used to form the first electrolyte layer and second electrolyte layer are the same, except for polymer additives, for manufacturing conveniences.

A soluble conductive polymer is believed to impregnate the pores of anodes as effectively as conductive polymers formed by in-situ methods and better than conductive polymer dispersion with detectable particles. Neither in-situ conductive polymer nor soluble conductive polymer contains polyanion dopants such as polystyrene sulfonic acid. In many cases, soluble conductive polymers contain self-doping functionalities.

The first solid electrolyte layer or second solid electrolyte layer may comprise a crosslinkers and organometallic additives to improve inter-layer adhesion. Crosslinkers are particularly preferred in the first solid electrolytic layer. Crosslinkers are well known in the art as exemplified in U.S. Pat. Nos. 8,882,856, 9,761,347, 9,761,378, 10,109,428, 10,643,796 which are incorporated herein by reference. Cross-linking comprises the use of a material comprising at least two cross-linkable functionalities wherein one cross-linkable functionality forms a first bond and the second cross-linkable functionality forms a second bond thereby forming a bridge of cross-linking molecule between two molecules, oligomers, polymer or portions of a polymer. For the purposes of this disclosure the term “crosslinked” is defined as the reaction product of a crosslinker since the crosslinker is not present as a separate compound after crosslinking. The cross-linkable functionality may form a covalent bond or an ionic bond.

The crosslinking may be between functional groups of the conductive polymer or a molecule, oligomer, or polymer. Crosslinkable functionality can be added to the conductive polymer layers thereby improving the layer integrity and the surface coverage or a crosslinkable material may be added to the conductive polymer layer. Once exposed to curing conditions, which is typically thermal curing, the crosslinkable molecules react with the crosslinker thereby forming a strongly bound interpenetrating network of covalent and ionic bonds. The crosslinkable materials preferably comprise two components with one component preferably being a compound, oligomer or polymer with multifunctional or multiple reactive groups which are well known in the art. The reactive groups are preferably selected from the group consisting of carboxylic, hydroxyl, amine, epoxy, anhydride, isocyanate, imide, amide, carboxyl, carboxylic anhydride, silane, oxazoline, (meth)acrylates, vinyls, maleates, maleimides, itaconates, allyl alcohol esters, dicyclo-pentadiene-based unsaturations, unsaturated C₁₂-C₂₂ fatty esters or amides, carboxylic acid salts, quaternary ammonium salts, polyester, polyurethane, polyamide, polyamine, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins and reactive polyamides. The oligomer or polymer with multifunctional or multiple reactive groups preferably includes at least one carboxylic acid group and at least one hydroxyl function group. A particularly preferred oligomer or polymer with multifunctional reactive groups is a polyester containing carboxylic and hydroxyl functionality. In addition to oligomers or polymers, particles with surface functional groups can also take part in the crosslinking.

Crosslinkers includes silane compounds and epoxy compounds. Particularly preferred crosslinkers comprise melamines, isocyanates, epoxies, hexamethoxymelamines, glyoxals, furfural aldehydes, melamine formaldehyde condensates, divinyl sulfones and epoxy compounds.

Organometallic additives includes organophosphorus compounds and organofunctional silanes. Organofunctional silanes and organic compounds with more than one crosslinking group, especially more than one epoxy group, are particularly suitable for use as crosslinkers for the instant invention especially when used in combination.

An exemplary organofunctional silane is defined by the formula:

XR₁Si(R₃)₃₋ₙ(R₂)ₙ

wherein X is an organic functional group such as amino, epoxy, anhydride, hydroxy, mercapto, sulfonate, carboxylate, phosphonate, halogen, vinyl, methacryloxy, ester, alkyl, etc; R₁ is an aryl or alkyl (CH2) m wherein m can be 0 to 14; R₂ is individually a hydrolysable functional group such as alkoxy, acyloxy, halogen, amine or their hydrolyzed product; R₃ is individually an alkyl functional group of 1-6 carbons; n is 1 to 3.

The organofunctional silane can also be dipodal, define by the formula:

Y (Si (R₃) 3-n (R₂) n) 2wherein Y is any organic moiety that contains reactive or nonreactive functional groups, such as alkyl, aryl, sulfide or melamine; R₃, R₂ and n are defined above. The organofunctional silane can also be multi-functional or polymeric silanes, such as silane modified polybutadiene, or silane modified polyamine, etc.

Particularly preferred organofunctional silanes are selected from the group consisting of: 3-glycidoxypropyltrimethoxysilane, 3-aminopropytriethoxysilane, aminopropylsilanetriol, (triethoxysilyl) propylsuccinic anhydride, 3-mercaptopropyltrimethoxysilane, vinyltrimethoxysilane, 3-methacryloxypropyltrimethoxysilane, 3-trihydroxysilyl-1-propane sulfonic acid, octyltriethyoxysilane, bis (triethoxysilyl) octane, etc. The examples are used to illustrate the invention and should not be regarded as conclusive.

A particularly preferred organofunctional silane is glycidyl silane defined by the formula:

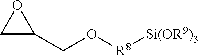

wherein R⁸ is an alkyl of 1 to 14 carbons and more preferably selected from methyl ethyl and propyl; and each R⁹ is independently an alkyl or substituted alkyl of 1 to 6 carbons.

A particularly preferred glycidyl silane is 3-glycidoxypropyltrimethoxysilane defined by the formula:

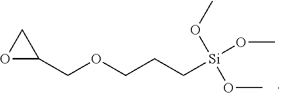

A crosslinker with at least two epoxy groups is referred to herein as an epoxy crosslinking compound and is defined by the formula:

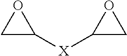

wherein the X is an alkyl or substituted alkyl of 0-14 carbons, preferably 0-6 carbons; an aryl or substituted aryl, an ethylene ether or substituted ethylene ether, polyethylene ether or substituted polyethylene ether with 2-20 ethylene ether groups or combinations thereof. A particularly preferred substitute is an epoxy group.

Particularly preferred epoxy crosslinking compounds having more than one epoxy groups are selected from the group consisting of: ethylene glycol diglycidyl ether (EGDGE), propylene glycol diglycidyl ether (PGDGE), 1,4-butanediol diglycidyl ether (BDDGE), pentylene glycol diglycidyl ether, hexylene glycol diglycidyl ether, cyclohexane dimethanol diglycidyl ether, resorcinol glycidyl ether, glycerol diglycidyl ether (GDGE), glycerol polyglycidyl ethers, diglycerol polyglycidyl ethers, trimethylolpropane polyglycidyl ethers, sorbitol diglycidyl ether (Sorbitol-DGE), sorbitol polyglycidyl ethers, polyethylene glycol diglycidyl ether (PEGDGE), polypropylene glycol diglycidyl ether, polytetramethylene glycol diglycidyl ether, di(2,3-epoxypropyl)ether, 1,3-butadiene diepoxide, 1,5-hexadiene diepoxide, 1,2,7,8-diepoxyoctane, 1,2,5,6-diepoxycyclooctane, 4-vinyl cyclohexene diepoxide, bisphenol A diglycidyl ether, maleimide-epoxy compounds, etc.

Mixtures of the crosslinkers may be used.

Additives in first solid electrolyte layer includes phosphate.

The preferred polythiophene is shown as polymerized in Formula A:

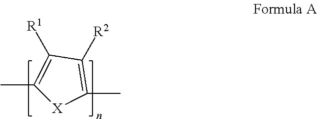

wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements. R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;

### X is S; and

n represents that the compound of Formula A is a polymer with a range of molecular weights; in general n is an integer of 2 to a number sufficient to reach an average molecular weight of about 500,000.

R¹ and R² of Formula A are preferably chosen to prohibit polymerization at the β-site of the ring as it is most preferred that only α-site polymerization be allowed to proceed. It is more preferred that R¹ and R² are not hydrogen and more preferably, R¹ and R² are a-directors with ether linkages being preferable over alkyl linkages. It is most preferred that the R¹ and R² are small to avoid steric interferences.

In a particularly preferred embodiment R¹ and R² of Formula A are taken together to represent —O—(CHR⁴)ₘ—O— wherein m is an integer from 1 to 5 and most preferably 2; each R⁴ is independently selected from hydrogen, a linear or branched C₁ to C₁₈ alkyl radical C₅ to C₁₂ cycloalkyl radical, C₆ to C₁₄ aryl radical C₇ to C₁₈ aralkyl radical or C₁ to C₄ hydroxyalkyl radical, optionally substituted with a functional group selected from carboxylic acid, hydroxyl, amine, substituted amines, alkene, acrylate, thiol, alkyne, azide, sulfate, sulfonate, sulfonic acid, imide, amide, epoxy, anhydride, silane, and phosphate; hydroxyl radical; or R⁴ is selected from —(CHR⁵)ₐ—R¹⁶; —O(CHR⁵)ₐR¹⁶; —CH₂O(CHR⁵)ₐR¹⁶; —CH₂O(CH₂CHR⁵O)ₐR¹⁶, or

R⁴ is a functional group selected from the group consisting of hydroxyl, carboxyl, amine, epoxy, amide, imide, anhydride, hydroxymethyl, alkene, thiol, alkyne, azide, sulfonic acid, benzene sulfonic acid sulfate, SO₃M, anhydride, silane, acrylate and phosphate; R⁵ is H or alkyl chain of 1 to 5 carbons optionally substituted with functional groups selected from carboxylic acid, hydroxyl, amine, alkene, thiol, alkyne, azide, epoxy, acrylate and anhydride. R¹⁶ is H, —SO₃M or an alkyl chain of 1 to 5 carbons optionally substituted with functional groups selected from carboxylic acid, hydroxyl, amine, substituted amines, alkene, thiol, alkyne, azide, amide, imide, sulfate, SO₃M, amide, epoxy, anhydride, silane, acrylate and phosphate. a is integer from 0 to 10. M is a H or cation preferably selected from ammonia, sodium or potassium.

A particularly preferred polymer is 3,4-polyethylene dioxythiophene (PEDOT) which is prepared from monomeric 3,4-ethylene dioxythiophene (EDOT).

Particularly preferred conductive polymers include poly(3,4-ethylenedioxythiophene), poly(4-(2,3-dihydrothieno-[3,4-b][1,4]dioxin-2-yl)methoxy)-1-butane-sulphonic acid, salt), poly(4-(2,3-dihydrothieno-[3,4-b][1,4]dioxin-2-yl)methoxy)-1-propane-sulphonic acid, salt), poly(4-(2,3-dihydrothieno-[3,4-b][1,4]dioxin-2-yl)methoxy)-1-methyl-1-propane-sulphonic acid, salt), poly(4-(2,3-dihydrothieno-[3,4-b][1,4]dioxin-2-yl)methoxy alcohol, poly(N-methylpyrrole), poly(3-methylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), polythiophene, poly(3-methylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-ethylenedioxythiophene), poly(3,4-propylenedioxythiophene), poly(3,4-butenedioxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-aniline sulfonate), poly(3-aniline sulfonate), and the like.

Particularly suitable polymers or co-polymers are selected from the group consisting of poly(4-(2,3-dihydrothieno-[3,4-b][1,4]dioxin-2-yl)methoxy)-1-butane-sulphonic acid, salt), poly(4-(2,3-dihydrothieno-[3,4-b][1,4]dioxin-2-yl)methoxy)-1-methyl-1-propane-sulphonic acid, salt), poly(N-methylpyrrole), poly(3-methylthiophene), poly(3-methoxythiophene), and poly(3,4-ethylenedioxythiophene).

Preferred polyanions are described in U.S. Pat. No. 10,340,091 with polystyrene sulfonate being particularly preferred.

The insulating resin is not particularly limited herein with any non-electrically conducting compatible resin being suitable for demonstration of the invention. If the electrolytic capacitor is embedded or encased the resin optional.

### EXAMPLES

Solid Electrolyte A comprises poly(3,4-ethylenedioxythiophene) and polystyrene sulfonate with a mean particle size of 20 nm and 10-90 wt % of epoxy crosslinker and additives. Solid Electrolyte B comprises poly(3,4-ethylenedioxythiophene) and polystyrene sulfonate with a mean particle size of 20 nm and 10-90 wt % of polyvinyl alcohol polymer and additives. Solid Electrolyte C comprises poly(3,4-ethylenedioxythiophene) and polystyrene sulfonate with a mean particle size of 20 nm and 10-90 wt % polyethylene oxide. Solid Electrolyte D comprises poly(3,4-ethylenedioxythiophene) and polyanion copolymers and 10-90 wt % epoxy oligomers, adhesion promoters, surfactants, and additives.

### Example 1

A series of 100 microfarads, 35V tantalum anodes were prepared. The tantalum was anodized to form a dielectric on the tantalum anode. An organic compound based on silane was applied on the dielectric. The anodes were dipped in the oxidizer, iron tosylate, followed by dipping in EDOT monomer followed by drying and washing to form a conductive polymer in-situ. A first solid electrolyte was f Solid Electrolyte A, was applied. A second solid electrolyte D was formed on the first solid electrolyte. After drying, alternating layers of an amine salt and the second conductive polymer dispersion D was applied and repeated 4-5 more times. The anodes with the conductive polymer layers were washed and dried, followed by sequential coating of a graphite layer and a silver layer to produce a solid electrolytic capacitor. Parts were assembled and packaged. Capacitance and ESR was measured on packaged parts.

### Example 2

A series of 100 microfarads, 35V tantalum anodes were prepared. The tantalum was anodized to form a dielectric on the tantalum anode. An organic compound based on silane was applied on the dielectric. The anodes were dipped in the oxidizer, iron tosylate, followed by dipping in EDOT monomer to form a conductive polymer in-situ. After drying and washing a First Solid Electrolyte B, was applied. A second solid electrolyte D was formed on the first solid electrolyte After drying, alternating layers of an amine salt and the second conductive polymer dispersion D was applied and repeated 4-5 more times. The anodes with the conductive polymer layers were washed and dried, followed by sequential coating of a graphite layer and a silver layer to produce a solid electrolytic capacitor. Parts were assembled and packaged. Capacitance and ESR was measured on packaged parts

### Example 3

A series of 100 microfarads, 35V tantalum anodes were prepared. The tantalum was anodized to form a dielectric on the tantalum anode. An organic compound based on silane was applied on the dielectric. The anodes were dipped in the oxidizer, iron tosylate, followed by dipping in EDOT monomer drying and washing to form a conductive polymer in-situ. After this, first solid electrolyte C, was applied. A second solid electrolyte D was formed on the first solid electrolyte. After drying, alternating layers of an amine salt and the second conductive polymer dispersion D was applied and repeated 4-5 more times. The anodes with the conductive polymer layers were washed and dried, followed by sequential coating of a graphite layer and a silver layer to produce a solid electrolytic capacitor. Parts were assembled and packaged. Capacitance and ESR was measured on packaged parts

Electrochemical impedance measurements (EIS) were carried out to investigate the ionic conductivity of solid electrolytes A, B, C and D. EIS model for mixed ionic-electronic conductors, assumes that electronic conductivity is much greater than ionic conductivity. Thus, it can be considered that the values calculated via EIS method gives only ion transport values. So ionic conductivity was measured via EIS.

Sample electrodes were prepared by drop casting aqueous solutions of solid electrolytes A, B, C and D (thickness 1 mm) on a 1 cm² masked area of conductive Ta foil and placed in an open electrochemical cell containing 1 (M) KCl in water with the working electrode lead attached to the exposed Ta foil. Counter electrode lead was attached to another Ta foil in a 2-electrode configuration. The cell was connected to a Hioki Chemical Impedance Analyzer (IM3590) and was oscillated with a 10 mV AC perturbation (no dc control) from 100 KHz to 10⁻² Hz.

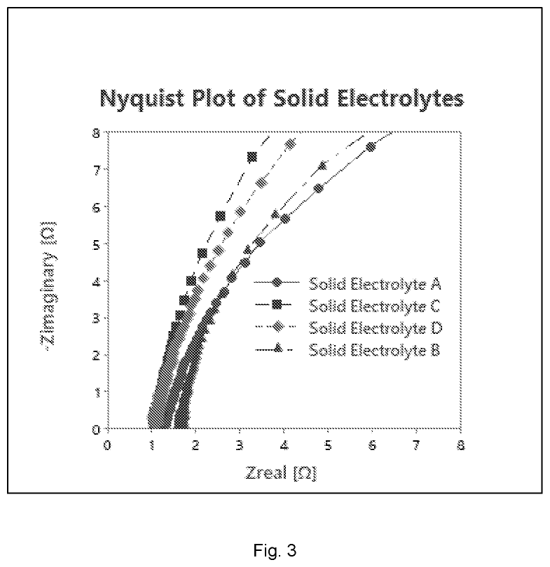

The ionic resistance (R), illustrated graphically in FIG. 3 was derived from the width of 45° high-frequency region of the resulting Nyquist plots between the high and (extrapolated) low-frequency intercepts (Zreal) and accounting for electrode area (A) and thickness (t), which were calculated from equation: (J. Chem. Soc., Faraday Trans., 1990,86, 3631-3636) R=t/(3(Zreal (low)−Zreal (high))×A) where Z real is the real part of the impedance.

Alternatively, ionic conductivity is given by 1/R.

Glass transition temperature was determined using differential scanning calorimeter.

Table 1 shows the ionic conductivity and glass transition temperature of the solid electrolytes A,B,C, and D

| | | Glass Transition | |
|---|---|---|---|
| Solid Electrolyte | Ionic Conductivity (S/cm) | Temperature | |
| Solid electrolyte A | 0.125 | >50 | C. |
| Solid electrolyte B | 0.08 | >50 | C. |
| Solid electrolyte C | 0.25 | −26 | C. |
| Solid electrolyte D | 0.06 | 98 | C. |

Power Cycling Test was done at ambient room temperature, with rated voltage on for 5 seconds, followed by turning off the voltage for 5 seconds. The voltage on/off power cycle was repeated for 50,000 times. Capacitance of the parts were tested before and after the power cycling cycles and the change in capacitance, Delta Cap, is calculated and presented in Table 2.

TABLE 2

| | First Solid | | Ionic | |
|---|---|---|---|---|
| | Electrolyte | Glass Transition | Conductivity | |
| | (SE), | temperature T_{g} | (S/cm) first | |
| | Second solid | (° C.) (first SE, | SE, second | Delta |
| Examples | electrolyte | second SE) | SE | Cap |
| Example 1 | A, D | >50, 98 C. | 0.125, 0.06 | −26 |
| Example 2 | B, D | >50, 98 C. | 0.08, 0.06 | −33 |
| Example 3 | C, D | −25, 98 C. | 0.25, 0.06 | −13 |

The results show a significant improvement when a first layer, comprising a low T_{g} polymer and a second layer thereon, comprising a high T_{g} polymer provides significant improvements in capacitance loss due to power cycling with a capacitance loss after at least 50,000 surge cycles of less than 15%. Results also shows delta cap is lower when the ionic conductivity of the first solid electrolyte is higher than the second solid electrolyte.

The invention has been described with reference to preferred embodiments without limit thereto. One of skill in the art would realize additional embodiments which are described and set forth in the claims appended hereto.

Claimed is:

1. A solid electrolytic capacitor with an improve capacitance stability comprising:
an anode with a dielectric on said anode;
a cathode on said dielectric wherein said cathode comprises:
a first solid electrolyte layer wherein said first solid electrolyte layer with a glass transition temperature below 0° C.; and
a second solid electrolyte layer wherein said second solid electrolyte layer with a glass transition temperature of at least 50° C.

2. The solid electrolytic capacitor of claim 1 wherein said first solid electrolyte layer has an ionic conductivity which is higher than an ionic conductivity of said second solid electrolyte.

3. The solid electrolytic capacitor of claim 1 wherein said cathode further comprises an internal layer.

4. The solid electrolytic capacitor of claim 1 wherein said first solid electrolyte layer comprises a first polymer selected from the group consisting of: poly(triethyleneglycol methyl vinyl ether); poly[2-(2-ethoxy)ethoxyethyl vinyl ether]; poly(2-ethoxyethyl vinyl ether); poly(ethyl vinyl ether); poly(iso-propyl vinyl ether); poly(n-propyl vinyl ether); poly(n-butyl vinyl ether); poly(iso-butyl vinyl ether); poly(2-ethylhexyl vinyl ether); poly(trimethylene carbonate-co-ε-caprolactone); polytrimethylene oxide; poly(ethylene) oxide; poly(propylene oxide); poly(ethylene oxide)-co-poly(propylene oxide) copolymers; polyvinylidene fluoride; poly(vinylidene fluoride-hexafluoropropylene); poly(ethylene imine); poly(3-hydroxypropyl ethyleneimine); poly[bis((methoxyethoxy)ethoxy)phosphazene]; poly[bis{poly(ethylene glycol) methylether}phosphazene]; poly[bis{poly(oxyethylene(4)) laurylether}phosphazene] and oly[bis-((methoxyethoxy)ethoxy)phosphazene].

5. The solid electrolytic capacitor of claim 1 wherein said a second solid electrolyte layer comprises a second polymer selected from the group consisting of: polyester, polyurethane, polyamide, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins or reactive polyamides.

6. The solid electrolytic capacitor of claim 1 wherein said anode comprises a material selected from the group consisting of niobium, aluminum, tantalum and NbO.

7. The solid electrolytic capacitor of claim 1 wherein said anode has a charge density of at least 50,000 CV/g.

8. The solid electrolytic capacitor of claim 7 wherein said anode has a charge density above 100,000 CV/g.

9. The solid electrolytic capacitor of claim 8 wherein said anode has a charge density above 200,000 CV/g.

10. The solid electrolytic capacitor of claim 9 wherein said anode has a charge density above 250,000 CV/g.

11. The solid electrolytic capacitor of claim 1 wherein said anode has a charge density of up to 350,000 CV/g.

12. The solid electrolytic capacitor of claim 1 wherein at least one of said first solid electrolytic layer or said second solid electrolytic layer comprises a conductive polymer.

13. The solid electrolytic capacitor of claim 12 wherein said conductive polymer is represented by Formula A: 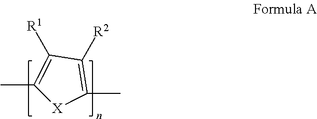
wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n is an integer of 2 to a number sufficient to reach an average molecular weight of about 500,000.

14. The solid electrolytic capacitor of claim 13 wherein said conductive polymer is 3,4,polyethylene dioxythiophene.

15. The solid electrolytic capacitor of claim 1 wherein at least one of said first solid electrolytic layer or said second solid electrolytic layer comprises a polyanion.

16. The solid electrolytic capacitor of claim 1 wherein at least one of the first solid electrolytic layer or the second solid electrolytic layer further comprises a cross-linker.

17. The solid electrolytic capacitor of claim 16 wherein said cross-linker comprises at a reactive group selected from the group consisting of carboxylic, hydroxyl, amine, epoxy, anhydride, isocyanate, imide, amide, carboxyl, carboxylic anhydride, silane, oxazoline, (meth)acrylates, vinyls, maleates, maleimides, itaconates, allyl alcohol esters, dicyclo-pentadiene-based unsaturations, unsaturated C₁₂-C₂₂ fatty esters or amides, carboxylic acid salts, quaternary ammonium salts, polyester, polyurethane, polyamide, polyamine, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins and reactive polyamides.

18. A solid electrolytic capacitor with an improve capacitance stability comprising:
an anode with a dielectric on said anode;
a cathode on said dielectric wherein said cathode comprises:
a first solid electrolyte layer wherein said first solid electrolyte layer comprises a first polymer with a first glass transition temperature; and
a second solid electrolyte layer wherein said second solid electrolyte layer comprises a second polymer with a second glass transition temperature which is higher than said first glass transition temperature.

19. The solid electrolytic capacitor of claim 18 wherein said cathode further comprises an internal layer.

20. The solid electrolytic capacitor of claim 18 wherein said first polymer is selected from the group consisting of: poly(triethyleneglycol methyl vinyl ether); poly[2-(2-ethoxy)ethoxyethyl vinyl ether]; poly(2-ethoxyethyl vinyl ether); poly(ethyl vinyl ether); poly(iso-propyl vinyl ether); poly(n-propyl vinyl ether); poly(n-butyl vinyl ether); poly(iso-butyl vinyl ether); poly(2-ethylhexyl vinyl ether); poly(trimethylene carbonate-co-ε-caprolactone); polytrimethylene oxide; poly(ethylene) oxide; poly(propylene oxide); poly(ethylene oxide)-co-poly(propylene oxide) copolymers; polyvinylidene fluoride; poly(vinylidene fluoride-hexafluoropropylene); poly(ethylene imine); poly(3-hydroxypropyl ethyleneimine); poly[bis((methoxyethoxy)ethoxy)phosphazene]; poly[bis{poly(ethylene glycol) methylether}phosphazene]; poly[bis{poly(oxyethylene(4)) laurylether}phosphazene] and oly[bis-((methoxyethoxy)ethoxy)phosphazene].

21. The solid electrolytic capacitor of claim 18 wherein said second polymer is selected from the group consisting of: polyester, polyurethane, polyamide, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins or reactive polyamides.

22. The solid electrolytic capacitor of claim 18 wherein said anode comprises a material selected from the group consisting of niobium, aluminum, tantalum and NbO.

23. The solid electrolytic capacitor of claim 18 wherein said anode has a charge density of at least 50,000 CV/g.

24. The solid electrolytic capacitor of claim 23 wherein said anode has a charge density above 100,000 CV/g.

25. The solid electrolytic capacitor of claim 24 wherein said anode has a charge density above 200,000 CV/g.

26. The solid electrolytic capacitor of claim 25 wherein said anode has a charge density above 250,000 CV/g.

27. The solid electrolytic capacitor of claim 18 wherein said anode has a charge density of up to 350,000 CV/g.

28. The solid electrolytic capacitor of claim 18 wherein at least one of said first solid electrolytic layer or said second solid electrolytic layer comprises a conductive polymer.

29. The solid electrolytic capacitor of claim 28 wherein said conductive polymer is represented by Formula A: 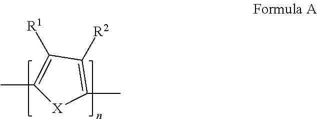
wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n is an integer of 2 to a number sufficient to reach an average molecular weight of about 500,000.

30. The solid electrolytic capacitor of claim 29 wherein said conductive polymer is 3,4,polyethylene dioxythiophene.

31. The solid electrolytic capacitor of claim 18 wherein at least one of said first solid electrolytic layer or said second solid electrolytic layer comprises a polyanion.

32. The solid electrolytic capacitor of claim 18 wherein at least one of the first solid electrolytic layer or the second solid electrolytic layer further comprises a cross-linker.

33. The solid electrolytic capacitor of claim 32 wherein said cross-linker comprises at a reactive group selected from the group consisting of carboxylic, hydroxyl, amine, epoxy, anhydride, isocyanate, imide, amide, carboxyl, carboxylic anhydride, silane, oxazoline, (meth)acrylates, vinyls, maleates, maleimides, itaconates, allyl alcohol esters, dicyclo-pentadiene-based unsaturations, unsaturated C₁₂-C₂₂ fatty esters or amides, carboxylic acid salts, quaternary ammonium salts, polyester, polyurethane, polyamide, polyamine, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins and reactive polyamides.

34. The solid electrolytic capacitor of claim 18 wherein said first solid electrolyte layer has a first ionic conductivity; and said second solid electrolyte layer has a second ionic conductivity wherein said first ionic conductivity is higher than said second ionic conductivity.

35. A solid electrolytic capacitor with an improve capacitance stability comprising:
an anode with a dielectric on said anode;
a cathode on said dielectric wherein said cathode comprises:
a first solid electrolyte layer with a first ionic conductivity; and
a second solid electrolyte layer with a second ionic conductivity wherein said first ionic conductivity is higher than said second ionic conductivity.

36. The solid electrolytic capacitor of claim 35 wherein said cathode further comprises an internal layer.

37. The solid electrolytic capacitor of claim 35 wherein said first polymer is selected from the group consisting of: poly(triethyleneglycol methyl vinyl ether); poly[2-(2-ethoxy)ethoxyethyl vinyl ether]; poly(2-ethoxyethyl vinyl ether); poly(ethyl vinyl ether); poly(iso-propyl vinyl ether); poly(n-propyl vinyl ether); poly(n-butyl vinyl ether); poly(iso-butyl vinyl ether); poly(2-ethylhexyl vinyl ether); poly(trimethylene carbonate-co-ε-caprolactone); polytrimethylene oxide; poly(ethylene) oxide; poly(propylene oxide); poly(ethylene oxide)-co-poly(propylene oxide) copolymers; polyvinylidene fluoride; poly(vinylidene fluoride-hexafluoropropylene); poly(ethylene imine); poly(3-hydroxypropyl ethyleneimine); poly[bis((methoxyethoxy)ethoxy)phosphazene]; poly[bis{poly(ethylene glycol) methylether}phosphazene]; poly[bis{poly(oxyethylene(4)) laurylether}phosphazene] and oly[bis-((methoxyethoxy)ethoxy)phosphazene].

38. The solid electrolytic capacitor of claim 35 wherein said second polymer is selected from the group consisting of: polyester, polyurethane, polyamide, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins or reactive polyamides.

39. The solid electrolytic capacitor of claim 35 wherein said anode comprises a material selected from the group consisting of niobium, aluminum, tantalum and NbO.

40. The solid electrolytic capacitor of claim 35 wherein said anode has a charge density of at least 50,000 CV/g.

41. The solid electrolytic capacitor of claim 40 wherein said anode has a charge density above 100,000 CV/g.

42. The solid electrolytic capacitor of claim 41 wherein said anode has a charge density above 200,000 CV/g.

43. The solid electrolytic capacitor of claim 42 wherein said anode has a charge density above 250,000 CV/g.

44. The solid electrolytic capacitor of claim 35 wherein said anode has a charge density of up to 350,000 CV/g.

45. The solid electrolytic capacitor of claim 35 wherein at least one of said first solid electrolytic layer or said second solid electrolytic layer comprises a conductive polymer.

46. The solid electrolytic capacitor of claim 45 wherein said conductive polymer is represented by Formula A: 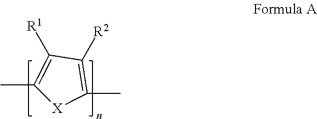
wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n is an integer of 2 to a number sufficient to reach an average molecular weight of about 500,000.

47. The solid electrolytic capacitor of claim 46 wherein said conductive polymer is 3,4,polyethylene dioxythiophene.

48. The solid electrolytic capacitor of claim 35 wherein at least one of said first solid electrolytic layer or said second solid electrolytic layer comprises a polyanion.

49. The solid electrolytic capacitor of claim 35 wherein at least one of the first solid electrolytic layer or the second solid electrolytic layer further comprises a cross-linker.

50. The solid electrolytic capacitor of claim 49 wherein said cross-linker comprises at a reactive group selected from the group consisting of carboxylic, hydroxyl, amine, epoxy, anhydride, isocyanate, imide, amide, carboxyl, carboxylic anhydride, silane, oxazoline, (meth)acrylates, vinyls, maleates, maleimides, itaconates, allyl alcohol esters, dicyclo-pentadiene-based unsaturations, unsaturated C₁₂-C₂₂ fatty esters or amides, carboxylic acid salts, quaternary ammonium salts, polyester, polyurethane, polyamide, polyamine, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins and reactive polyamides.

51. A solid electrolytic capacitor with an improve capacitance stability comprising:
an anode with a dielectric on said anode;
a cathode on said dielectric wherein said cathode comprises:
a first solid electrolyte layer wherein said first solid electrolyte layer comprises a first polymer with a glass transition temperature below 0° C.; and
a second solid electrolyte layer wherein said second solid electrolyte layer comprises a second polymer with a glass transition temperature of at least 50° C.;
wherein after at least 50,000 surge cycles said solid electrolytic capacitor exhibits a capacitance loss of less than 15%.

52. The solid electrolytic capacitor of claim 51 wherein said cathode further comprises an internal layer.

53. The solid electrolytic capacitor of claim 51 wherein said first polymer is selected from the group consisting of: poly(triethyleneglycol methyl vinyl ether); poly[2-(2-ethoxy)ethoxyethyl vinyl ether]; poly(2-ethoxyethyl vinyl ether); poly(ethyl vinyl ether); poly(iso-propyl vinyl ether); poly(n-propyl vinyl ether); poly(n-butyl vinyl ether); poly(iso-butyl vinyl ether); poly(2-ethylhexyl vinyl ether); poly(trimethylene carbonate-co-ε-caprolactone); polytrimethylene oxide; poly(ethylene) oxide; poly(propylene oxide); poly(ethylene oxide)-co-poly(propylene oxide) copolymers; polyvinylidene fluoride; poly(vinylidene fluoride-hexafluoropropylene); poly(ethylene imine); poly(3-hydroxypropyl ethyleneimine); poly[bis((methoxyethoxy)ethoxy)phosphazene]; poly[bis{poly(ethylene glycol) methylether}phosphazene]; poly[bis{poly(oxyethylene(4)) laurylether}phosphazene] and oly[bis-((methoxyethoxy)ethoxy)phosphazene].

54. The solid electrolytic capacitor of claim 51 wherein said second polymer is selected from the group consisting of: polyester, polyurethane, polyamide, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins or reactive polyamides.

55. The solid electrolytic capacitor of claim 51 wherein said anode comprises a material selected from the group consisting of niobium, aluminum, tantalum and NbO.

56. The solid electrolytic capacitor of claim 51 wherein said anode has a charge density of at least 50,000 CV/g.

57. The solid electrolytic capacitor of claim 56 wherein said anode has a charge density above 100,000 CV/g.

58. The solid electrolytic capacitor of claim 57 wherein said anode has a charge density above 200,000 CV/g.

59. The solid electrolytic capacitor of claim 58 wherein said anode has a charge density above 250,000 CV/g.

60. The solid electrolytic capacitor of claim 51 wherein said anode has a charge density of up to 350,000 CV/g.

61. The solid electrolytic capacitor of claim 51 wherein at least one of said first solid electrolytic layer or said second solid electrolytic layer comprises a conductive polymer.

62. The solid electrolytic capacitor of claim 61 wherein said conductive polymer is represented by Formula A: 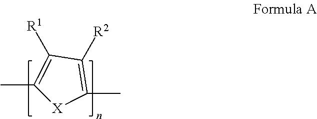
wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-Cs cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n is an integer of 2 to a number sufficient to reach an average molecular weight of about 500,000.

63. The solid electrolytic capacitor of claim 62 wherein said conductive polymer is 3,4,polyethylene dioxythiophene.

64. The solid electrolytic capacitor of claim 51 wherein at least one of said first solid electrolytic layer or said second solid electrolytic layer comprises a polyanion.

65. The solid electrolytic capacitor of claim 51 wherein at least one of the first solid electrolytic layer or the second solid electrolytic layer further comprises a cross-linker.

66. The solid electrolytic capacitor of claim 65 wherein said cross-linker comprises at a reactive group selected from the group consisting of carboxylic, hydroxyl, amine, epoxy, anhydride, isocyanate, imide, amide, carboxyl, carboxylic anhydride, silane, oxazoline, (meth)acrylates, vinyls, maleates, maleimides, itaconates, allyl alcohol esters, dicyclo-pentadiene-based unsaturations, unsaturated C₁₂-C₂₂ fatty esters or amides, carboxylic acid salts, quaternary ammonium salts, polyester, polyurethane, polyamide, polyamine, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins and reactive polyamides.

67. A method for forming a solid electrolytic capacitor comprising:
forming a dielectric on an anode; and
forming a cathode on said dielectric wherein said cathode comprises:
forming a first solid electrolyte layer wherein said first solid electrolyte layer comprises a first polymer with a glass transition temperature below 0° C.; and
forming a second solid electrolyte layer on said first solid electrolyte layer wherein said second solid electrolyte layer comprises a second polymer with a glass transition temperature of at least 50° C.

68. The method for forming a solid electrolytic capacitor of claim 67 further comprising forming an internal layer prior to said forming of said first solid electrolyte layer.

69. The method for forming a solid electrolytic capacitor of claim 67 wherein said first polymer is selected from the group consisting of: poly(triethyleneglycol methyl vinyl ether); poly[2-(2-ethoxy)ethoxyethyl vinyl ether]; poly(2-ethoxyethyl vinyl ether); poly(ethyl vinyl ether); poly(iso-propyl vinyl ether); poly(n-propyl vinyl ether); poly(n-butyl vinyl ether); poly(iso-butyl vinyl ether); poly(2-ethylhexyl vinyl ether); poly(trimethylene carbonate-co-E-caprolactone); polytrimethylene oxide; poly(ethylene) oxide; poly(propylene oxide); poly(ethylene oxide)-co-poly(propylene oxide) copolymers; polyvinylidene fluoride; poly(vinylidene fluoride-hexafluoropropylene); poly(ethylene imine); poly(3-hydroxypropyl ethyleneimine); poly[bis((methoxyethoxy)ethoxy)phosphazene]; poly[bis{poly(ethylene glycol) methylether}phosphazene]; poly[bis{poly(oxyethylene(4)) laurylether}phosphazene] and oly[bis-((methoxyethoxy)ethoxy)phosphazene].

70. The method for forming a solid electrolytic capacitor of claim 67 wherein said is selected from the group consisting of polyester, polyurethane, polyamide, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins or reactive polyamides.

71. The method for forming a solid electrolytic capacitor of claim 67 wherein said anode comprises a material selected from the group consisting of niobium, aluminum, tantalum and NbO.

72. The method for forming a solid electrolytic capacitor of claim 67 wherein said anode has a charge density of at least 50,000 CV/g.

73. The method for forming a solid electrolytic capacitor of claim 72 wherein said anode has a charge density above 100,000 CV/g.

74. The method for forming a solid electrolytic capacitor of claim 73 wherein said anode has a charge density above 200,000 CV/g.

75. The method for forming a solid electrolytic capacitor of claim 74 wherein said anode has a charge density above 250,000 CV/g.

76. The method for forming a solid electrolytic capacitor of claim 67 wherein said anode has a charge density of up to 350,000 CV/g.

77. The method for forming a solid electrolytic capacitor of claim 67 wherein at least one of said first solid electrolytic layer or said second solid electrolytic layer comprises a conductive polymer.

78. The method for forming a solid electrolytic capacitor of claim 77 wherein said conductive polymer is represented by Formula A: 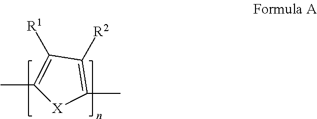
wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n is an integer of 2 to a number sufficient to reach an average molecular weight of about 500,000.

79. The method for forming a solid electrolytic capacitor of claim 78 wherein said conductive polymer is 3,4,polyethylene dioxythiophene.

80. The method for forming a solid electrolytic capacitor of claim 67 wherein at least one of said first solid electrolytic layer or said second solid electrolytic layer comprises a polyanion.

81. The method for forming a solid electrolytic capacitor of claim 67 wherein at least one of the first solid electrolytic layer or the second solid electrolytic layer further comprises a cross-linker.

82. The method for forming a solid electrolytic capacitor of claim 81 wherein said cross-linker comprises at a reactive group selected from the group consisting of carboxylic, hydroxyl, amine, epoxy, anhydride, isocyanate, imide, amide, carboxyl, carboxylic anhydride, silane, oxazoline, (meth)acrylates, vinyls, maleates, maleimides, itaconates, allyl alcohol esters, dicyclo-pentadiene-based unsaturations, unsaturated C₁₂-C₂₂ fatty esters or amides, carboxylic acid salts, quaternary ammonium salts, polyester, polyurethane, polyamide, polyamine, polyimide, silicone polyester, hydroxyl functional silicone, hydroxyethyl cellulose, polyvinyl alcohol, phenolic, epoxy, butyral, copolymers of these or mixture of these multifunctional polymers such as epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene resins and reactive polyamides.
